(19) United States
(12) Patent Application Publication
(10) Pub. No.: US 2009/0283012 A1
(43) Pub. Date: Nov. 19, 2009

(54) Addition of Spent Activated Carbon to Asphalt Compositions and to Coking Units as Feedstock or Quencher

(75) Inventors: John E. Partanen, Colton, CA (US); Stanley W. Ellis, Bakersfield, CA (US); Travis F. Ellis, Bakersfield, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Stanley W. Ellis, Bakersfield, CA (US)

(21) Appl. No.: 12/533,823

(22) Filed: Jul. 31, 2009

Related U.S. Application Data
(62) Division of application No. 11/744,399, filed on May 4, 2007.

(51) Int. Cl. C09D 195/00

(52) U.S. Cl. 106/284.01

(57) ABSTRACT

An asphalt mastic is prepared by combining spent activated carbon, that has not been regenerated, with liquid asphalt to achieve a composition that is useful for a variety of applications for which asphalt is used, including aggregate compositions and roofing materials. The activated carbon can also serve as a foaming initiator for the production of foamed asphalt. Still further, the activated carbon can be used as coking unit feedstock and as a quencher for a delayed coking unit.

### CROSS REFERENCE TO RELATED APPLICATION

This application is a division of co-pending U.S. patent application Ser. No. 11/744,399, filed May 4, 2007 the contents of which are incorporated herein by reference.

### BACKGROUND OF THE INVENTION

1. Field of the Invention

This invention resides in asphalt technology and asphalt formulations, and also in waste management, particularly in connection with petroleum refinery operations and other industrial facilities where activated carbon is used.

2. Description of the Prior Art

Activated carbon is used by petroleum refineries and other industrial facilities for the removal of light sulfur compounds, light organic compounds, and light hydrocarbons from liquid and vapor streams to enable the facilities to operate safely and to conform to established environmental regulations. Activated carbon is produced by the charring of fibrous plant materials such as coconut shells, corn husks, and nutshells, and also by partial combustion of anthracite coal, sub-bituminous coal and bituminous coal. The charred carbon remains from these sources are first pulverized, then saturated with water, and finally heated rapidly to convert the water to steam. As the steam escapes, the carbon particles expand and the surface area of the particles and accordingly their adsorptivity increase. The resulting activated carbon is available in various forms, including granules, pellets, and powders. Granules and pellets of activated carbon range in size from 4 mm (0.157 inch) to 30 microns (0.0117 inch), while powdered activated carbon has a typical particle size of from 150 microns (0.0059 inch) to less than 45 microns (0.0017 inch).

The term “spent activated carbon” is used in the industry to denote activated carbon that has lost all or a significant amount of its absorptive capacity and is no longer useful as an adsorbent. Spent activated carbon must either be discarded and replaced by fresh activated carbon or regenerated. Regeneration of activated carbon is achieved by heat treatment at temperatures of 600° C. (1,112° F.) to 90020 C. (1,65220 F.), and because of the energy consumed in this treatment the price of regenerated activated carbon is nearly equal to the price of new activated carbon. As a result, many refineries and other industrial facilities send their spent activated carbon to waste handling facilities such as landfills rather than either sending it to regeneration facilities or regenerating it on-site. Spent activated carbon that has been sent to landfills cannot be recovered and reused. The need for cost-effective treatment or utilization of spent activated carbon is thus of importance to industry as well as to the environment and to human health.

Of possible relevance to the background of this invention is the use of carbon black as a mineral filler in asphalt compositions. In a paper presented in 1997 to the American Society of Civil Engineers, Park and co-workers reported that the addition of pyrolyzed carbon black improves asphalt pavement performance by increasing Marshall stability, decreasing permanent strain or flow, and increasing the stripping inflection point, i.e., reducing stripping. Park, T., et al., “Use of Pyrolyzed Carbon Black as Additive in Hot Mix Asphalt,” Journal of Transportation Engineering, November/December 1997, pp. 489-494. Pyrolyzed carbon black, however, is neither a regenerated nor recycled material.

Of further possible relevance is the use of coking operations in petroleum refineries as a means of disposing of or recycling waste materials. Disclosures of such uses are found in Bartilucci, M. P., et al., U.S. Pat. Nos. 4,874,805 and 5,009,767, both entitled “Recycling of Oil Refinery Wastes,” with issue dates Oct. 17, 1989, and Apr. 23, 1991, respectively.

Of further possible relevance to the background of this invention is a naturally occurring asphalt known as Trinidad Lake Asphalt. This asphalt is mined from a pitch lake in the southwest of Trinidad and contains 30% water, which is readily removed by a simple refining process, leaving a molten material with a soluble bitumen content of 53-55% and a fine particulate mineral content of 36-37%. The lake is in a natural basin above a geological formation containing heavy crude oil. As the oil seeps upward, it passes through layers of rock, drawing the minerals from the rock and carrying them with it until it reaches the basin as a suspension of fine mineral particles in the crude oil. Once the oil is in the basin and exposed to the atmosphere, the light ends of the oil evaporate to leave the mineral-impregnated asphalt. Trinidad Lake Asphalt is noted for its unusually high resistance to stress and environmental conditions, and products made from Trinidad Lake Asphalt offer the advantage of a long life with low maintenance. Trinidad Lake Asphalt, either by itself or in combination with other materials, is particularly useful, for example, as a surface covering on roadways that receive high traffic, such as freeways, bridges, off-ramps, and the like. Trinidad Lake Asphalt can be applied to these surfaces at reduced thicknesses and yet perform at a level that is equivalent to or better than that of other asphalts. Trinidad Lake Asphalt is also used as a binder for crushed mineral aggregate, typically ⅜-¾ inch (approximately 1-2 cm) in size, to form stone mastic asphalt. Mastic asphalt in general, also referred to as “asphalt mastic,” is widely used as a building material in floors, paved areas, decks, and roofing. Trinidad Lake Asphalt is however a natural product from a single source, and while its value is recognized worldwide, the need to package it and transport it to sites of use adds considerably to its cost. An asphalt similar in performance to Trinidad Lake Asphalt that utilizes petroleum refinery waste solids is Partanen, J. E., et al., U.S. Pat. No. 7,025,822 B2, issued Apr. 11, 2006.

### SUMMARY OF THE INVENTION

It has now been discovered that an asphalt-based suspension can be prepared by combining spent, comminuted activated carbon with a liquid asphalt composition. The suspension can be used by itself as a construction material with a wide range of end uses, including applications where asphalt mastics of the prior art are used, and as a binder for stone mastic asphalt and other asphalt-aggregate compositions, and as asphalt-based roofing materials such as protective roof coatings and adhesives for roof insulation. The spent activated carbon can also be used to induce foaming in liquid asphalt compositions in the production of foamed asphalts. This invention makes effective use of spent activated carbon without the expense of regeneration and without the need for waste disposal and its attendant costs and environmental concerns. The composition of the suspension and its physical properties can also be varied to meet specific needs and requirements, and the suspension can be supplemented by additives, such as rubber and other polymers, that are common in conventional asphalt compositions, with the same benefits that these additives provide to conventional asphalt compositions.

It has also been discovered that spent, comminuted activated carbon can be used as a supplement to coker feedstocks in petroleum refineries and as a quenching medium during the quench phase of the coking cycle. Quenching is achieved by suspending the spent activated carbon, usually received in granular, pellet, or powdered form, in oil or water to form a slurry. The slurry is then injected into the feedstock for the coking unit or into petroleum coke to quench portions of the coke that are still hot as the coke is removed from the coking unit and stockpiled.

This invention thus resides in novel compositions that contain spent activated carbon and novel processes for utilizing and/or disposing of spent activated carbon. The compositions include the activated carbon suspended in liquid asphalt, and cured and/or solidified forms of these compositions, and also compositions and materials of construction that contain these compositions in combination with other materials such as conventional aggregate materials, polymeric additives, or both. The processes include those that involve asphalt processing or formulation and those that involve coking operations. These and other features, embodiments, goals, and advantages of the invention will be more evident from the description that follows.

### DETAILED DESCRIPTION OF THE INVENTION AND PREFERRED EMBODIMENTS

As noted above, this invention is directed to the use of spent, unregenerated activated carbon. The term “spent” denotes activated carbon that has been used for the treatment of liquids and gases by adsorption from the liquids and gases of any of the variety of contaminants and pollutants that activated carbon is known to be capable of removing, and through extended use has lost all of its adsorptive capacity, or so much thereof that it no longer provides value as an adsorbent or is economically useful as an adsorbent. The term “unregenerated” denotes that the activated carbon has not been treated to restore its adsorptive capacity, such treatment typically being achieved by exposure to a temperature above 700° F. (370° C.), often with in the range of about 750° F. (400° C.) to about 1,000 ° F. (540° C.), and most often within the range of about 800° F. (430° C.) to about 900° F. (480° C.), to achieve this result. (All temperature conversions in this specification are approximate and rounded to the nearest 10° C.) The loss of adsorptive capacity will in most cases be attributable to a loss of pore volume, surface area, or both due to the presence of adsorbed matter in the pores, particularly matter that was present as contaminants and pollutants in the fluids and vapors in which the activated carbon was used. Spent, unregenerated activated carbons referred to in this specification include those that may have been previously spent two or more times and regenerated between uses, but not regenerated subsequent to the last time they were spent, i.e., their last absorptive use.

Spent activated carbon that is useful in the present invention has a small particle size, preferably with most particles having a longest dimension of about 250 microns or less. In most cases, the spent activated carbon will have to be pulverized or otherwise comminuted to achieve this particle size. In certain embodiments, it will be desirable to use particles whose longest dimension is a maximum of about 100 microns, and in certain other embodiments, the longest dimension will be a maximum of about 50 microns. When using United States Sieve Series mesh sizes, a useful particle size is minus 70 mesh (i.e., passing through a sieve opening of 210 microns), a smaller particle size for certain end uses is minus 200 mesh (passing through a sieve opening of 75 microns), and a still smaller particle size for certain end uses is minus 325 mesh (passing through a sieve opening of 45 microns). Size reduction can be achieved by conventional equipment. Examples are compression devices such as jaw crushers, gyratory crushers, roll crushers, ring-roll mills, ring-ball mills, hammer mills, sledge mills, vibration mills, stamp mills, rod mills, ball mills, pebble mills, and attrition mills. The choice of equipment will depend on the composition of the spent activated carbon, its hardness, and its initial size distribution, and on whether the size reduction is to be performed wet or dry, and also on the desired degree of size reduction. For most applications, hammer mills, ball mills, and rod mills are preferred. Wet size reduction can be performed by first suspending the activated carbon in either aqueous solutions or in oils, while dry size reduction is performed directly on the spent activated carbon without the use of a suspending medium. When size reduction is performed on a suspension, a colloid mill can serve as the size reduction equipment. In all cases, the term “longest dimension” as used herein refers to linear dimensions, and generally refers to the size of the smallest sieve opening through which the particle will pass in any orientation. For a spherical particle, the longest dimension is the diameter, while for an elongated particle, the longest dimension is the length of the particle.

In certain embodiments of the invention, the spent activated carbon is exposed to a mild heat treatment prior to use to extract a portion of the organic or sulfur-bearing material retained in the pores, but not to the extent of regeneration. Certain volatile organics can be extracted from the pores of the carbon by heating the carbon to a temperatures below 100° F. (38° C.), while light sulfur compounds, other light hydrocarbons, other organics, and water can be extracted by heating the carbon to a temperature of about 212° F. (100° C.) to about 600° F. (300° C.), either prior to or subsequent to the size reduction, for a sufficient period of time to volatilize the contaminants that will be released at the selected temperature. A preferred temperature range for this treatment is about 275° F. (135° C.) to about 500° F. (260° C.). The materials extracted in this manner can be collected and removed for external uses or, when wet size reduction is practiced, recycled back to the size reduction phase to supplement the suspending medium.

As noted above, one of the uses of spent unregenerated activated carbon in accordance with this invention is in the manufacture of foamed asphalt. Foamed asphalt is a form of asphalt that has a reduced viscosity and improved adherence, thereby offering certain advantages for mixing with aggregates. The alteration that foaming imparts to the properties of the asphalt is temporary, achieving its benefits during the initial stages of the application of the asphalt to surfaces or the forming of the asphalt into its ultimate shape and form. Foaming is achieved by the generation of steam within the asphalt composition to form bubbles that expand the asphalt, and the steam is generated in the prior art by the injection of high-pressure steam or by the addition of unheated water to a stream of hot asphalt. In the practice of the present invention, foaming is achieved by moisture retained in the spent activated carbon itself without the separate addition of steam or water. The retained moisture can be the result of allowing the spent activated carbon to absorb moisture from the atmosphere, or can be actively added by contacting the spent activated carbon with liquid water. Absorption of moisture from the atmosphere can be achieved by exposing the carbon to the atmosphere at normal humidity levels and a temperature of about 30° C. or below, preferably at a temperature of about 15° C. to about 25° C., for a period of from 2-3 days to four weeks or more. Contact with liquid water rather than atmospheric exposure but at the same temperature will result in a comparable moisture level over a time period of less than four hours. For foaming purposes, a moisture level of at least about 1% will provide effective results. A moisture level of from about 1% to about 25% by weight is preferred, and a moisture level of from about 5% to about 10% by weight is the most preferred. Moisturization is preferably performed after size reduction, and after the extraction of sulfur and hydrocarbon values when such extraction is performed, and before contact with the liquid asphalt composition. Contact with the liquid asphalt composition is performed at a temperature at which the moisture will produce spontaneous foaming, preferably about 250° F. (120° C.) or higher, and most preferably from about 255° F. (125° C.) to about 480° F. (250° C.).

The liquid asphalt in which the spent, unregenerated activated carbon is suspended can be derived from native asphalts, rock asphalts, or petroleum asphalts, as well as modified and/or blended asphalts. Petroleum-derived asphalts are preferred. The liquid form of the asphalt can be achieved by heating any asphalt to a temperature above its softening temperature (i.e., liquefied asphalt), or by blending an asphalt with a petroleum distillate fraction such as gas oil, kerosene, naphtha, or any other petroleum-derived oil that is liquid at ambient temperature, to achieve a composition known as a cutback asphalt, or by dispersing liquid asphalt in water to form an emulsion. The suspension can thus be designed for use in preparing either hot mix asphalts or cold mix asphalts, and a key factor in selecting between the two is the choice of liquid asphalt. Asphalts that are not diluted with diluents such as hydrocarbons or water to render the asphalt flowable at ambient temperature are used in preparing hot mix asphalts, while asphalts that are liquid at ambient temperatures, such as cutback asphalts and asphalt emulsions, are used in preparing cold mix asphalts. Asphalts for use in hot mix asphalts typically require heating to about 300° F. (about 150° C.) or above to be in flowable liquid form.

For use as cold mix asphalts, cutback asphalts can be formulated as slow-curing, medium-curing, or rapid-curing, depending on the amount of diluent and the kinematic viscosity of the blended product. Examples of diluents are petroleum-base lube oils, recycled motor oils, recycled motor oil fluxes, petroleum-base lube oil extracts, asphalt fluxes, tall oil products, and vegetable oils. Asphalt emulsions generally include an emulsifying agent, which can be either cationic, anionic, or nonionic. Anionic emulsifying agents commonly used in asphalt emulsions are sodium or potassium palmitate, stearate, linoleate, and abietate, and combinations of these. Typical cationic agents are diamines such as N-octadecyl-1,3-propanediamine hydrochloride. Typical nonionic emulsifying agents are nonionic cellulose derivatives. The emulsions are typically prepared in colloid mills. A typical emulsion may contain petroleum asphalt at 50-75% by weight colloidally suspended at 140-200° F. (60-95° C.) in an aqueous phase containing caustic soda or other bases, or acids, and one of the emulsifying agents listed above.

Examples of asphalts suitable for use in this invention are penetration graded asphalts such as those known in the industry as 30-40 pen, 40-50 pen, 50-60 pen, 85-100 pen, and 120-150 pen; asphalt cements such as those known in the industry as AC-5, AC-10, AC-20, AC-30, and AC-40; aged residue asphalts such as those known in the industry as AR-1000, AR-2000, AR-4000, AR-8000, and AR-16,000; and performance graded asphalts such as those known in the industry as PG 58-28, PG 64-22, PG 70-16, PG 70-10, and PG 76-10.

The proportion of spent, unregenerated activated carbon to liquid asphalt in the compositions of this invention is not critical to the invention and can vary depending on the desired grade of the final product and its intended use. In most cases, best results will be achieved with compositions in which the weight ratio of activated carbon to liquid asphalt composition is from about 0.05:1 to about 1:1, preferably from about 0.1:1 to about 0.67:1, and most preferably from about 0.2:1 to about 0.5:1. The suspension can be formed by conventional mixing methods, preferably with the asphalt component heated to a temperature high enough to permit uniform dispersion of the activated carbon throughout the asphalt. The suspension can be formed in a vertical mix tank equipped with a vertically suspended moderate-to-high-speed mixer, or a horizontal mix tank with a central shaft equipped with paddles, helical coils, or both.

Suspensions in accordance with this invention can be supplemented by the inclusion of rubbers and other polymers to modify and improve the physical and mechanical performance of the final material, and particularly for increasing stress resistance. Examples of these rubbers and other polymers are butyl rubbers, polybutadiene, polyisoprene, polyisobutene, ethylene/vinyl acetate copolymer, polyacrylate, polymethacrylate, polychloroprene, polynorbornene, ethylene/propylene/diene (EPDM) terpolymer, styrene butadiene styrene co-block polymers, styrene isoprene styrene co-block polymers, styrene butadiene polymers, random or block copolymers of styrene and a conjugated diene, ethylene vinyl acetate polymers, low-density ethylene polymers, vinyl acrylic polymers, and low-density acrylic polymers. Recycled tire rubber is widely used and particularly convenient as a polymeric additive. A water-dispersible polymer thickener can also be included. One example is NATROSOL® 250 HR (Aqualon Co., Wilmington, Del., USA), a hydroxyethyl cellulose. When included, these polymers preferably constitute from about 0.5% to about 15% by weight of the final composition. When rubbers are present, sulfur can also be included as an additive to vulcanize the rubber.

When used in the formation of an asphalt-aggregate composition, the suspension of spent, unregenerated activated carbon in asphalt in accordance with this invention is combined with solid particles known in the art as aggregate. The term “aggregate” in this context denotes any hard, inert, and typically mineral material that is included for strengthening purposes, decorative purposes, or both. Examples of aggregate are sand, gravel, crushed stone, coral, marble, and slag. Recycled pavement material is also used as aggregate. When present, the aggregate typically constitutes from about 20% to about 97% by weight of the composition. In cold mix asphalts, the aggregate typically constitutes from about 20% to about 90% of the mixture, and in hot mix asphalts, the aggregate typically constitutes from about 90% to about 97% of the mixture.

When the invention is used in the formation of hot mix asphalts, the hot mixes can be prepared in conventional hot mix plants, including batch plants and drum mix drier plants. These plants include a rotary drum into which the sieved aggregate, recycled asphalt pavement, or both, is introduced and heated. Heating is achieved by a large natural gas or diesel-fired burner. The aggregate and recycled asphalt pavement is rotated around the flame as the drum rotates. In a batch-type plant, the heated aggregate or recycled asphalt pavement (or both) is placed in a large pugmill together with the dehydrated centrifuge waste solids and the additives such as polymer or recycled tire rubber. The entire combination is milled until a uniform mixture is achieved. In drum mix drier plants, the asphalt binder and additives can be introduced directly into the rotating drum itself, and mixing occurs in the drum. Once the mixes are uniform, they can be conveyed to heated storage silos for loading into transport trucks, or directly into transport trucks, particularly when the mixes are prepared in batch-type plants.

For those embodiments of the invention in which the spent but unregenerated activated carbon is used as feedstock or a quench medium for a coking unit, the coking operation can be one performed under conventional coking conditions. In such an operation, a petroleum fraction is heated by direct heat exchange with the hot, vaporous cracking products and the light components of the feed are removed by contact with the hot cracking products. The remaining material is then heated in a furnace to a temperature of about 700° C. to 1,100° C., then fed to a delayed coking drum under conditions that promote thermal cracking. The lighter cracking products are removed from the drum in vapor form while the remaining products condense and polymerize to form a porous coke mass. In a delayed coking unit, two or more coke drums are used in sequence with the feed being fed to each drum in turn during the coking phase of the cycle until the drum is substantially full. The feed is then switched to the next coking drum while the first drum is stripped of volatile cracking products by steam. The coke is then quenched and removed from the coking drum.

The spent but unregenerated activated carbon is fed to the coking drum as a slurry, either in oil or in an aqueous liquid such as water, waste water, or aqueous solutions in general. The proportion of activated carbon in the slurry is not critical and can vary, provided only that it remain in suspension. In most cases, best results will be achieved with a slurry in which the activated carbon constitutes from about 1% to about 40% by weight. In certain embodiments, a suspending agent is included in the slurry, and any of various clays and gums known in the art can be used for this purpose. Examples are locust bean gum, guar gum, xanthan gum, kaolin clay, bentonite, sepeolite, attapulgite, and hectorite. The amount of gum or clay can vary widely, but will be included in a particle-suspending amount, which in most cases will be within the range of about 0.5% to about 5% by weight. The amount of slurry that is fed to the coking unit can vary as well, depending on the conditions of the unit and the materials contained in the slurry. In most cases, effective results will be obtained with the slurry constituting from about 0.5% to about 20% of the feed or the drum contents.

For slurries using oil as the suspending medium, any petroleum-based oil can be used. Examples are diesel oil, gas oil, catalytic cracker oil, bunker fuel oil, and liquid asphalt. The spent activated carbon for these embodiments can be used with or without heat treatment, and with or without size reduction. For embodiments in which the spent activated carbon is heat treated before the oil slurry is prepared, the carbon is preferably crushed in a hammer mill, ball mill, or rod mill prior to heating. Likewise for water-based slurries, the spent activated carbon can be used with or without heat treatment, and with or without size reduction.

In the following examples, the term “recycled activated carbon” refers to spent but unregenerated activated carbon, and all such activated carbon was pulverized to minus 70 mesh particle size prior to use. All percents are by weight unless otherwise indicated.

### EXAMPLE 1

This example illustrates the use of an asphalt mastic in accordance with this invention as a hot applied joint and crack sealant.

A mixture was prepared by combining the following components in the proportions as indicated: petroleum asphalt, 59.03%; recycled motor oil flux, 13.00%; recycled activated carbon, 17.00%; styrene-butadiene-styrene (SBS) copolymer, 2.90%; sulfur, 0.07%; and granulated recycled tire rubber, 8.00%. The preparation procedure consisted of combining all components except the activated carbon and heating the combination to 135° C. (275° F.), followed by slowly adding the activated carbon. The resulting mixture began to boil immediately as the water, light sulfur compounds, light organic compounds, and light hydrocarbons previously adsorbed by the activated carbon were released into the hot oil and asphalt mixture. The mixture was then stirred and heated to 232° C. (450° F.) to drive off the water, light sulfur compounds and light hydrocarbons and other organics. The mixture was then allowed to cool to 204° C. (400° F.) and the SBS copolymer, sulfur, and granulated recycled tire rubber were added sequentially with high shear mixing while the temperature was maintained at between 135° C. (275° F.) and 204° C. (400° F.) for one hour with moderate agitation. The properties of the product were then determined with the following results:

| | |
|---|---|
| Density at 25° C. (77° F.) | 1.046 g/cc, 8.72 lb/gal |
| Viscosity at 190° C. (374° F.) | 2,811 cps |
| Softening Point | 97° C. (206.6° F.) |
| Cone Penetration at 25° C. (77° F.) | 67 dmm |
| Resilience at 25° C. (77° F.) | 43% |
| Flexibility at −18° C. (0° F.) | Pass |
| Flow at 60° C. (140° F.) | 1 mm |
| Bond at −18° C. (0° F.) | Pass |

These test results indicate that the product complies with specifications for ASTM D 6690 Type I Joint and Crack Sealant, Hot Applied, for Concrete and Asphalt Pavements.

### EXAMPLE 2

This example illustrates the use of recycled activated carbon in accordance with this invention in making foamed asphalt for use as an asphalt base material.

Pulverized recycled activated carbon that had been heat treated as in Example 1 to drive off light sulfur compounds and light organics was allowed to stand at room temperature for one week. During this one-week period, the carbon absorbed approximately 8.0% moisture from the atmosphere. A 22-gram quantity of the moist carbon was added to 44 grams of petroleum asphalt at 135° C. (275° F.), and the resulting mixture was stirred. The mixture foamed immediately, and while foaming continued, 1100 grams of cold, minus ½-inch recycled asphalt pavement was added and the resulting mixture was stirred until uniform. This mixture was then compacted in a 4-inch Marshall mold in three layers, with each layer receiving 25 blows with a Marshall hammer. Upon completion of the compaction procedure, the specimen was extracted from the mold and examined.

The specimen contained 94.34% minus ½-inch recycled asphalt pavement, 3.77% petroleum asphalt, and 1.89 % pulverized recycled activated carbon, and was determined to be satisfactory as a stabilized recycled asphalt base material.

### EXAMPLE 3

This example illustrates the use of recycled activated carbon in accordance with this invention in making an asphalt stone mastic warm mix.

A stone mastic asphalt aggregate having the following gradation (by U.S. Sieve Series) was prepared:

| Size Gradation | Specifications |
|---|---|
| 97.2% Passing the ½ inch Sieve | 85-100% |
| 69.3% Passing the ⅜ inch Sieve | 60-80% |
| 25.6% Passing the #4 Sieve | 20-40% |
| 17.4% Passing the #8 Sieve | 16-28% |
| 12.1% Passing the #50 Sieve | 8-18% |
| 3.5% Passing the #200 Sieve | 6-12% |

A 16.4-gram amount of pulverized recycled activated carbon containing 8% moisture, prepared as in Example 3, was placed in a mixing bowl, and 92.6 grams of petroleum asphalt at 135° C. (275° F.) was added. The resulting mastic asphalt mixture began to foam vigorously. A 1,100-gram quantity of stone mastic aggregate, pre-warmed to 135° C. (275° F.), was added to the foamed asphalt mastic mixture and stirred. The aggregate was easily covered by the foaming asphalt mastic mixture. The resulting foamed asphalt stone mastic warm mix was compacted in a Marshall mold as in Example 3, then extracted from the mold and allowed to sit overnight at ambient temperature. The bulk specific gravity of the resulting specimen was determined and the specimen was placed in a water bath at 60° C. (140° F.) for one hour, after which time it was tested on a Marshall compression machine for compressive strength and flow. The results were as follows:

| | |
|---|---|
| Bulk Specific Gravity at 25° C. | 2.2749 |
| Marshall Stability | 1,357 pounds |
| Marshall Flow | 0.22 inch |

The final product contained 91.00% stone mastic aggregate, 7.65% petroleum asphalt, and 1.35% recycled activated carbon.

### EXAMPLE 4

This example illustrates the use of recycled activated carbon in accordance with this invention in making an asphalt aggregate mastic warm mix using dense graded aggregate.

A dense graded aggregate having the following gradation (by U.S. Sieve Series) was prepared:

| Size Gradation | Specifications |
|---|---|
| 100% Passing the ½ inch Sieve | 100% |
| 91.1% Passing the ⅜ inch Sieve | 90-100% |
| 70.6% Passing the #4 Sieve | 60-80% |
| 52.6% Passing the #8 Sieve | 40-60% |
| 15.9% Passing the #50 Sieve | 6-25% |
| 9.2% Passing the #80 Sieve | 4-20% |
| 2.2% Passing the #200 Sieve | 2-10% |

A 22.6-gram amount of pulverized recycled activated carbon containing 8% moisture was placed in a mixing bowl, and 46.0 grams of petroleum asphalt at 135° C. (275° F.) was added. The resulting mastic asphalt mixture began to foam vigorously. A 1,150-gram quantity of the above dense graded aggregate, pre-warmed to 135° C. (275° F.), was added to the foamed asphalt mastic mixture and stirred. The aggregate was easily covered by the foaming asphalt mastic mixture. The resulting foamed asphalt dense graded warm mix was compacted in a Marshall mold as in the preceding examples, then extracted from the mold and allowed to sit overnight at ambient temperature. The bulk specific gravity of the resulting specimen was determined and the specimen was placed in a water bath at 60° C. (140° F.) for one hour, after which time it was tested on a Marshall compression machine for compressive strength and flow. The results were as follows:

| | |
|---|---|
| Bulk Specific Gravity at 25° C. | 2.0749 |
| Marshall Stability | 1,224 pounds |
| Marshall Flow | 0.13 inch |

The final product contained 94.37% dense graded aggregate, 3.77% petroleum asphalt, and 1.86% recycled activated carbon.

### EXAMPLE 5

This example illustrates the use of recycled activated carbon in accordance with this invention in making an asphalt aggregate mastic hot mix using dense graded aggregate.

A dense graded aggregate having the following gradation (by U.S. Sieve Series) was prepared:

| Size Gradation | Specifications |
|---|---|
| 100% Passing the ½ inch Sieve | 100% |
| 91.1% Passing the ⅜ inch Sieve | 90-100% |
| 70.6% Passing the #4 Sieve | 60-80% |
| 52.6% Passing the #8 Sieve | 40-60% |
| 15.9% Passing the #50 Sieve | 6-25% |
| 9.2% Passing the #80 Sieve | 4-20% |
| 2.2% Passing the #200 Sieve | 2-10% |

A mixture of 1 part pulverized recycled activated carbon containing 8% moisture and 2 parts petroleum asphalt was prepared and heated to 176.7° C. (350° F.) and stirred until foaming ceased. A 65.7 gram quantity of the mixture was then added to 1,034.3 g of the dense graded aggregate above. The resulting mixture was stirred until the aggregate was completely coated. This produced a foamed asphalt dense graded hot mix that was then compacted in a Marshall mold as in the preceding examples. The resulting specimen was allowed to cool in the mold for one hour, then extracted from the mold. The bulk specific gravity of the extracted specimen was determined and the specimen was placed in a water bath at 60° C. (140° F.) for one hour, after which time it was tested on a Marshall compression machine for compressive strength and flow. The results were as follows:

| | |
|---|---|
| Bulk Specific Gravity at 25° C. | 2.1356 |
| Marshall Stability | 1,392 pounds |
| Marshall Flow | 0.16 inch |

The final product contained 94.03% dense graded aggregate, 4.00% petroleum asphalt, and 1.97% recycled activated carbon.

### EXAMPLE 6

This example illustrates the use of recycled activated carbon in accordance with this invention in making an asphalt aggregate mastic hot mix using a combination of dense graded aggregate and recycled asphalt pavement.

A mixture of aggregates was prepared by combining 878.9 g of the dense graded aggregate of the preceding examples with 155.1 g of minus ½-inch recycled asphalt pavement, resulting in a weight ratio of 85:15 (dense graded aggregate to recycled asphalt pavement). The mixture was preheated to 176.7° C. (350° F.). Separately, a mixture of 1 part pulverized recycled activated carbon containing 8% moisture and 2 parts petroleum asphalt was prepared and heated to 176.7° C. (350° F.) and stirred until foaming ceased. A 65.7-gram quantity of the mixture was then added to the preheated 85:15 aggregate combination. The resulting mixture was stirred until the aggregate was completely coated. The resulting foamed asphalt-aggregate hot mix was compacted in a Marshall mold as described above, then allowed to cool in the mold for one hour, and finally extracted from the mold. The bulk specific gravity of the extracted specimen was determined and the specimen was placed in a water bath at 60° C. (140° F.) for one hour, after which time its compressive strength and flow characteristics were tested on a Marshall compression machine. The results were as follows:

| | |
|---|---|
| Bulk Specific Gravity at 25° C. | 2.0842 |
| Marshall Stability | 1,478 pounds |
| Marshall Flow | 0.15 inch |

The final product contained 79.90% dense graded aggregate, 14.10% recycled asphalt pavement, 4.00% petroleum asphalt, and 2.00% recycled activated carbon.

### EXAMPLE 7

This example illustrates the use of recycled activated carbon in accordance with this invention in making a non-foaming asphalt aggregate hot mix.

A mixture of 1 part pulverized recycled activated carbon and 2 parts petroleum asphalt was prepared and heated to 176.7° C. (350° F.). An 88-gram quantity of the heated mixture was combined with 1,100 grams of stone mastic asphalt aggregate that had been preheated to 176.7° C. (350° F.), and the resulting mixture was stirred until the aggregate was completely covered. The resulting stone mastic asphalt hot mix was then compacted in a Marshall mold as described above, then allowed to cool in the mold for one hour before being extracted. The bulk specific gravity of the extracted specimen was determined, and the specimen was then placed in a water bath at 60° C. (140° F.) for one hour. Its compressive strength and flow characteristics were then tested using a Marshall compression machine. The results were as follows:

| | |
|---|---|
| Bulk Specific Gravity at 25° C. | 2.2245 |
| Marshall Stability | 2,110 pounds |
| Marshall Flow | 0.13 inch |

The composition of the specimen was 92.59% dense graded aggregate, 4.96% petroleum asphalt, and 2.45% recycled activated carbon.

### EXAMPLE 8

This example illustrates the use of recycled activated carbon in accordance with this invention in making a dense graded asphalt aggregate hot mix that also contains a polymeric binder and recycled tire rubber.

A mixture was prepared by combining petroleum asphalt, 59.03%; recycled motor oil flux, 13.00%; recycled activated carbon, 17.00%; styrene-butadiene-styrene (SBS) copolymer, 2.90%; sulfur, 0.07%; and granulated recycled tire rubber, 8.00%, using the procedure of Example 1. The characteristics of the mixture were as follows:

| | |
|---|---|
| Density at 25° C. (77° F.) | 1.046 g/cc, 8.72 lb/gal |
| Viscosity at 190° C. (374° F.) | 2811 cps |
| Softening Point | 97° C. (206.6° F.) |
| Cone Penetration at 25° C. (77° F.) | 67 dmm |
| Resilience at 25° C. (77° F.) | 43% |
| Flexibility at −18° C. (0° F.) | Pass |
| Flow at 60° C. (140° F.) | 1 mm |
| Bond at −18° C. (0° F.) | Pass |

A 55-gram quantity of this asphalt mastic binder was combined with 1,045 grams of minus ½ inch dense graded asphalt aggregate (with size distribution as in Example 5 above) at 176.7° C. (350° F.), and the resulting mixture was stirred until the aggregate was completely coated. The resulting dense graded asphalt mastic hot mix was compacted in a Marshall mold as in the preceding examples, allowed to cool for one hour, and then extracted from the mold. The bulk specific gravity of the resulting specimen was then determined and then the specimen was placed in a water bath at 60 C (140 F) for one hour. The specimen was then tested for Marshall Stability and Flow using a Marshall compression machine, yielding the following results:

| | |
|---|---|
| Bulk Specific Gravity at 25° C. | 2.1379 |
| Marshall Stability | 1,275 pounds |
| Marshall Flow | 0.20 inch |

The composition of the specimen was 95.00% dense graded aggregate, 2.95% petroleum asphalt, 0.65% recycled motor oil flux, 0.85% recycled activated carbon, 0.14% SBS copolymer, 0.01% sulfur, and 0.40% recycled tire rubber.

### EXAMPLE 9

This example illustrates the use of recycled activated carbon in accordance with this invention in making an asphalt aggregate hot mix that contains a polymeric binder and recycled tire rubber and that uses a combination of dense graded aggregate and recycled asphalt pavement.

A 55-gram quantity of the asphalt mastic binder of Example 8 was combined with 888.3 grams of minus ½ inch dense graded asphalt aggregate (with size distribution as in Example 5 above at 176.7° C. (350° F.) and 156.7 grams of minus ½-inch pulverized recycled asphalt pavement (an 85:15 mix of the two aggregates), and the resulting mixture was stirred until the aggregate was completely coated. The resulting dense graded asphalt mastic hot mix was compacted in a Marshall mold as in the preceding examples, allowed to cool for one hour, and then extracted from the mold. The bulk specific gravity of the specimen was then determined and then the specimen was placed in a water bath at 60° C. (140° F.) for one hour. The specimen was then tested for Marshall Stability and Flow using a Marshall compression machine, yielding the following results:

| | | |
|---|---|---|
| Bulk Specific Gravity at 25° C. | 2.1217 | |
| Marshall Stability | 1,418 | pounds |
| Marshall Flow | 0.21 | inch |

The composition of the specimen was 80.75% dense graded aggregate, 14.25% recycled asphalt pavement, 2.95% petroleum asphalt, 0.65% recycled motor oil flux, 0.85% recycled activated carbon, 0.14% SBS copolymer, 0.01% sulfur, and 0.40% recycled tire rubber.

### EXAMPLE 10

This example illustrates the use of recycled activated carbon in accordance with this invention in making an asphalt aggregate hot mix that contains a polymeric binder and recycled tire rubber and that uses stone mastic aggregate as in Example 3.

An 88-gram quantity of the asphalt mastic binder of Examples 8 and 9 was combined with 1,110 grams of stone mastic asphalt aggregate at 176.7° C. (350° F.), and the resulting mixture was stirred until the aggregate was completely coated. The resulting dense graded asphalt mastic hot mix was compacted in a Marshall mold as in the preceding examples, allowed to cool for one hour, and then extracted from the mold. The bulk specific gravity of the resulting specimen was then determined and the specimen was then placed in a water bath at 60° C. (140° F.) for one hour. The specimen was then tested for Marshall Stability and Flow using a Marshall compression machine, yielding the following results:

| | | |
|---|---|---|
| Bulk Specific Gravity at 25° C. | 2.2684 | |
| Marshall Stability | 1,482 | pounds |
| Marshall Flow | 0.12 | inch |

The composition of the specimen was 92.59% stone mastic asphalt aggregate, 4.36% petroleum asphalt, 0.96% recycled motor oil flux, 1.82% recycled activated carbon, 0.22% SBS copolymer, 0.01% sulfur, and 0.58% recycled tire rubber.

### EXAMPLE 11

This example illustrates the use of recycled activated carbon in accordance with this invention in making an asphalt aggregate hot mix that contains a polymeric binder, recycled tire rubber, and a sand aggregate, and is suitable for use as a hot applied pothole repair mastic and as a hot applied asphalt bridge joint mastic.

A mixture was prepared by combining petroleum asphalt, 63.9%; recycled and refined motor oil flux, 21.7%; SBS copolymer, 4.7%; sulfur, 0.1%; and minus 30 mesh granulated recycled tire rubber, 9.6%, using a high-shear mixer at 135° C. (275° F.), followed by heating to 190° C. (374° F.). The characteristics of the mixture were as follows:

| | |
|---|---|
| Density at 25° C. (77° F.) | 1.0374 g/cc, 8.647 lb/gal |
| Viscosity at 190° C. (374° F.) | 2704 cps |
| Softening Point | 96° C. (204.8° F.) |
| Cone Penetration at 25° C. (77° F.) | 162 dmm |
| Resilience at 25° C. (77° F.) | 84% |
| Flexibility at −18° C. (0° F.) | Passes easily |
| Flexibility at −29° C. (−20° F.) | Passes |
| Flow at 60° C. (140° F.) | 4 mm |
| Bond at −18° C. (0° F.) | Passes |

This modified asphalt mixture containing polymer and recycled tire rubber complies with specifications for ASTM D 6690, Type IV Joint and Crack Sealants, Hot Applied, for Concrete and Asphalt Pavements.

Separately, an aggregate mixture was prepared by combining 92.5% minus ⅜-inch sand aggregate and 7.5% pulverized recycled activated carbon. The gradation of the sand aggregate was as follows:
100% passing the ⅜ inch sieve
93.2% passing the #4 sieve
68.2% passing the #8 sieve
41.5% passing the #30 sieve
23.0% passing the #50 sieve
13.7% passing the #80 sieve
4.0% passing the #200 sieve

The gradation of the combined sand and pulverized recycled activated carbon was as follows:
100% passing the ⅜ inch sieve
93.8% passing the #4 sieve
70.6% passing the #8 sieve
45.9% passing the #30 sieve
29.7% passing the #50 sieve
20.1 % passing the #80 sieve
11.1% passing the #200 sieve

The aggregate combination and the mastic mixture were both preheated to 190° C. (374° F.), and 7 parts of the combination were combined with 3 parts of the mastic mixture and stirred until a hot semi-liquid asphalt mastic repair mixture was obtained. This mixture was poured at 190° C. (374° F.) into a 3-inch by 4-inch by 1-inch mold and allowed to cool. The mixture self leveled prior to cooling, but not so that it lacked a skid resistant surface. The specimen obtained was determined to be satisfactory as a hot applied asphalt pothole repair mastic and as a hot applied asphalt bridge joint mastic. The composition of the specimen was 64.75% sand aggregate, 5.25% pulverized recycled activated carbon, 19.17% petroleum asphalt, 6.51% recycled and re-refined motor oil flux, 1.41% SBS polymer, 0.03% sulfur, and 2.88% minus 30 mesh granulated recycled tire rubber. Recycled materials thus constituted 14.64% of the specimen.

### EXAMPLE 12

This example illustrates the preparation of a slurry of pulverized recycled activated carbon in oil in accordance with this invention for use as a quenching aid for a coking unit.

A gas oil with an API gravity of 15.2, a density of 0.9646 g/cc, and a viscosity of 111 cps at 15.6° C. (60° F.) was used as the suspending medium. Pulverized recycled activated carbon (21 g) was added to the gas oil (400 g) and the resulting mixture was stirred with moderate-to-high agitation until a uniform slurry resulted. The density and viscosity of the slurry were measured at 15.6° C. (60° F.), and the results were a density of 0.9681 g/cc and a viscosity of 133 cps. The slurry consisted of 95% gas oil and 5% pulverized recycled activated carbon and is suitable for adding to the feedstock sent to a petroleum refining coking unit before the quenching and removal of petroleum coke from the unit.

### EXAMPLE 13

This is a further illustration of the preparation of a slurry of pulverized recycled activated carbon in oil in accordance with this invention for use as a quenching aid for a coking unit.

A mixture of 400 g of the same gas oil used in Example 12 and 267 g of pulverized recycled activated carbon was stirred with moderate-to-high agitation to form a uniform slurry. The slurry had a density of 1.1008 g/cc and a viscosity of 448 cps at 15.6° C. (60° F.). The slurry consisted of 60% gas oil and 40% pulverized recycled activated carbon, by weight, and, like that of Example 12, is suitable for adding to the feedstock sent to a petroleum refining coking unit before the quenching and removal of petroleum coke from the unit.

### EXAMPLE 14

This example illustrates the preparation of an aqueous slurry of pulverized recycled activated carbon in accordance with this invention for use as a quenching aid for a coking unit.

A quantity of recycled activated carbon that was still in pellet form and that weighed 264 g was added to 536 g of water, and the resulting mixture was subjected to high-shear mixing using a colloid mill in a recirculation mode. The high-shear mixing reduced the activated carbon to a particle size of minus 70 mesh (210 microns maximum) as an aqueous slurry. The slurry had the following characteristics:

| Residue by evaporation | 32.97% | |
|---|---|---|
| Density at 25° C. (77° F.) | 1.1007 | g/cc |
| Viscosity at 25° C. (77° F.) | 213 | cps |

The slurry consisted of 67.03% water and 32.97% pulverized recycled activated carbon, by weight, and is suitable for adding to the feedstock sent to a petroleum refinery coking unit before the quenching and removal of petroleum coke from the unit.

To prevent the solids from settling, bentonite clay (2.5%) was added with high-shear mixing in the colloid mill until a uniform mixture resulted. With the clay thus incorporated, the slurry had the following characteristics:

| Residue by evaporation | 33.17% | |
|---|---|---|
| Density at 25° C. (77° F.) | 1.1029 | g/cc |
| Viscosity at 25° C. (77° F.), 5 rpm | 33,598 | cps |
| Viscosity at 25° C. (77° F.), 10 rpm | 15,515 | cps |
| Viscosity at 25° C. (77° F.), 20 rpm | 7,490 | cps |
| Viscosity at 25° C. (77° F.), 50 rpm | 3,296 | cps |
| Viscosity at 25° C. (77° F.), 100 rpm | 1,552 | cps |

The clay-modified slurry was pseudoplastic, i.e., a shear thinning fluid with thixotropic characteristics. The composition of the clay-modified slurry was 65.35% water, 32.15% activated carbon, and 2.50% bentonite clay, and is suitable for adding to the feedstock sent to a petroleum refinery coking unit before the quenching and removal of petroleum coke from the unit.

### EXAMPLE 15

This is a further illustration of the preparation of a water-based slurry of pulverized recycled activated carbon in accordance with this invention for use as a quenching aid for a coking unit.

Recycled activated carbon (35 g) that had been heat treated was added to 665 g of water, and the resulting mixture was subjected to high-shear mixing using a colloid mill in a recirculation mode. The resulting slurry had the following characteristics:

| Residue by evaporation | 4.96% | |
|---|---|---|
| Density at 25° C. (77° F.) | 1.0152 | g/cc |
| Viscosity at 25° C. (77° F.) | 26 | cps |

To ensure that the activated carbon did not settle in storage, locust bean gum was added to the slurry at a concentration of 2% by weight, and the resulting mixture was again subjected to high-shear mixing in the colloid mill. This modified slurry had the following characteristics:

| Residue by evaporation | 6.860% | |
|---|---|---|
| Density at 25° C. (77° F.) | 1.0157 | g/cc |
| Viscosity at 25° C. (77° F.) | 150 | cps |

The inclusion of the locust bean gun prevented the settlement of the activated carbon for over 72 hours without imparting complex viscosity or thixotropic properties to the slurry.

### EXAMPLE 16

This example illustrates the use of a water-based slurry of pulverized recycled activated carbon as a component of an asphalt pavement seal coat.

A slurry was prepared with the following composition:

| | |
|---|---|
| water | 65.35% |
| pulverized recycled activated carbon | 32.15% |
| bentonite clay | 2.50% |

The slurry was combined with further components as listed below to form a seal coat:

| | |
|---|---|
| water | 22.96% |
| kaolin clay | 15.23% |
| shredded newspaper fiber | 0.38% |
| −30 mesh sand aggregate | 29.80% |
| SS-1h asphalt composition | 30.97% |
| slurry | 0.66% |

The seal coat properties were as follows:

| residue by evaporation | 64.22% | |
|---|---|---|
| viscosity at 25° C. (77° F.), 5 rpm | 22,256 | cps |
| viscosity at 25° C. (77° F.), 10 rpm | 9,256 | cps |
| viscosity at 25° C. (77° F.), 20 rpm | 3,606 | cps |
| viscosity at 25° C. (77° F.), 50 rpm | 2,140 | cps |
| viscosity at 25° C. (77° F.), 100 rpm | 1,412 | cps |
| dry film color | black | |
| wet track abrasion loss | −14.97 | g |

The wet material contained 0.22% pulverized recycled activated carbon, and the dry material contained 0.34%.

### EXAMPLE 17

This example illustrates the use of water-based slurry of pulverized recycled activated carbon as a component of a protective roof coating.

A bentonite roofing emulsion was made by preparing an aqueous clay mixture with the following ingredients:

| | |
|---|---|
| water | 94.35% |
| Wyoming bentonite | 5.20% |
| chromic acid | to pH 5-5.5 |

A PG 70-10 petroleum asphalt at 154.4° C. (310° F.) was added to the emulsion and the components were mixed in a high-shear colloid mill. To the resulting emulsion was added 5% heat-treated minus-200 mesh (75 micron maximum) pulverized recycled activated carbon. The final emulsion had the following composition:

| | |
|---|---|
| water | 48.45% |
| Wyoming bentonite | 2.52% |
| chromic acid | 0.22% |
| petroleum asphalt | 43.81% |
| activated carbon | 5.00% |

This material was determined to meet specifications for ASTM D 1227, Type III Emulsified Asphalt used as a protective coating for roofing.

### EXAMPLE 18

This example illustrates another use of pulverized recycled activated carbon in a protective roof coating, this time as a component in an anionic recycled tire rubber modified emulsion.

A mixture containing clay and water was prepared with the following composition:

| | |
|---|---|
| water | 92.00% |
| sodium hydroxide | 0.30% |
| nonylphenol surfactant | 2.00% |
| Utah bentonite | 5.75% |

The pH of this mixture at 20° C. was 12.0.

A second mixture was prepared at 190° C. (374° F.) with the following composition, using pulverized recycled activated carbon that had been heat treated and that passed a no. 200 mesh (75 micron) screen:

| | |
|---|---|
| PG 70-10 petroleum asphalt | 61.00% |
| recycled motor oil flux | 16.00% |
| activated carbon | 16.00% |
| −30 mesh recycled tire rubber | 7.00% |

The asphalt-containing mixture was slowly added to the clay-containing mixture using an immersed high-shear two-stage colloid mill turning at 3,500 rpm. The resulting product was a thick emulsion that was dark brown to nearly black in color, with the following composition:

| | |
|---|---|
| petroleum asphalt | 29.89% |
| recycled motor oil flux | 7.84% |
| activated carbon | 7.84% |
| recycled tire rubber | 3.43% |
| water | 46.92% |
| NaOH | 0.15% |
| nonylphenol surfactant | 1.02% |
| Utah bentonite | 2.91% |

This material was determined to meet specifications for ASTM D 1227, Type III Emulsified Asphalt used as a protective coating for roofing.

While the foregoing description describes various alternatives, still further alternatives will be apparent to those who are skilled in the art and are within the scope of the invention.

In the claims appended hereto, the term “a” or “an” is intended to mean “one or more.” The term “comprise” and variations thereof such as “comprises” and “comprising,” when preceding the recitation of a step or an element, are intended to mean that the addition of further steps or elements is optional and not excluded. All patents, patent applications, and other published reference materials cited in this specification are hereby incorporated herein by reference in their entirety. Any discrepancy between any reference material cited herein and an explicit teaching of this specification is intended to be resolved in favor of the teaching in this specification. This includes any discrepancy between an art-understood definition of a word or phrase and a definition explicitly provided in this specification of the same word or phrase.

What is claimed is:

1. A process for manufacturing a foamed asphalt composition, said process comprising:
(a) comminuting spent, unregenerated activated carbon to particles whose longest dimension is a maximum of about 250 microns;
(b) heating said comminuted activated carbon to an elevated temperature of from about 100° C. to about 300° C. to remove therefrom volatile species having boiling points below said elevated temperature;
(c) following removal of said volatile species therefrom, exposing said activated carbon to moisture to cause said activated carbon to absorb said moisture to a level of from about 1% to about 25% by weight; and
(d) combining said activated carbon with a liquid asphalt composition at a temperature of at least about 120° C. to cause said liquid asphalt composition to foam.

2. The process of claim 1 wherein step (d) is performed at a temperature of from about 120° C. to about 250° C.

3. The process of claim 1 wherein step (c) comprises contacting said comminuted activated carbon with liquid water.

4. The process of claim 1 wherein step (c) comprises contacting said comminuted activated carbon with atmospheric moisture.

5. The process of claim 1 wherein said moisture level of step (c) is from about 5% to about 10% by weight.

6. The process of claim 1 wherein said elevated temperature of step (b) is from about 125° C. to about 250° C.

7. The process of claim 1 wherein step (c) is performed at a temperature not exceeding about 30° C.

8. The process of claim 1 wherein the weight ratio of said activated carbon in step (a) to said liquid asphalt composition in step (d) is from about 0.05:1 to about 1:1.

9. The process of claim 1 wherein the weight ratio of said activated carbon in step (a) to said liquid asphalt composition in step (d) is from about 0.1:1 to about 0.67:1.

10. The process of claim 1 wherein the weight ratio of said activated carbon in step (a) to said liquid asphalt composition in step (d) is from about 0.2:1 to about 0.5:1.

11. The process of claim 1 wherein step (a) comprises comminuting said spent, unregenerated activated carbon to particles whose longest dimension is a maximum of about 100 microns.

12. The process of claim 1 wherein step (a) comprises comminuting said spent, unregenerated activated carbon to particles whose longest dimension is a maximum of about 50 microns.
